(19) United States
(12) Patent Application Publication
(10) Pub. No.: US 2025/0091259 A1
(43) Pub. Date: Mar. 20, 2025

(54) PROCESS FOR PRODUCING A THREE-DIMENSIONAL PRESSURE-SENSITIVE ADHESIVE PRODUCT FROM RADIATION-INDUCED REACTIVE PREPOLYMER MASS

(71) Applicant: Coroplast Fritz Müller GmbH & Co. KG, Wuppertal (DE)

(72) Inventors: Jochen Ringelkamp, Wuppertal (DE); Jan Wieneke, Wuppertal (DE); Mario Luenne, Erkrath (DE)

(21) Appl. No.: 18/727,176

(22) PCT Filed: Jan. 21, 2022
(86) PCT No.: PCT/EP2022/051371

§ 371 Date: Jul. 8, 2024

(51) Int. Cl. B29C 39/00; B29C 33/38; B29K 105/00; C09J 7/38

(52) U.S. Cl. CPC B29C 39/006; B29C 33/3842; C09J 7/385; B29K 2105/0002; B29K 2105/0097; B29K 2995/0097; C09J 2301/302; C09J 2301/416

(57) ABSTRACT

A process for producing a three-dimensional pressure-sensitive adhesive product (HKP) from radiation-induced reactive prepolymer composition (SRP), comprising the process steps:
a. providing a negative mold (NF) for the pressure-sensitive adhesive product (HKP),
b. filling the negative mold (NF) provided with the radiation-induced reactive prepolymer mass (SRP),
c. radiation-induced chemical conversion of the prepolymer mass (SRP) to the pressure-sensitive adhesive product (HKP), and
d. removal of the pressure-sensitive adhesive product (HKP) from the negative mold (NF).
   In order to overcome the disadvantages of conventional technology, the negative mold (NF) is produced by a thermoforming process using a positive mold (PF), a casting process for the radiation-induced reactive prepolymer mass (SRP) is used to fill the negative mold (NF) provided, and cooling (K) takes place during the radiation-induced chemical conversion of the prepolymer mass (SRP) to the pressure-sensitive adhesive product (HKP).

### CROSS REFERENCE TO RELATED APPLICATIONS

This application is a 35 U.S.C. § 371 national phase application of International Application No.: PCT/EP2022/051371, filed Jan. 21, 2022, the content of which is incorporated herein by reference in its entirety.

### FIELD

The present invention relates to a process for the production of a three-dimensional pressure-sensitive adhesive product from radiation-induced reactive prepolymer composition. The invention also relates to a three-dimensional pressure-sensitive adhesive product made from a radiation-induced reactive prepolymer composition.

### BACKGROUND

The statements in this section merely provide background information related to the present disclosure and several definitions for terms used in the present disclosure and may not constitute prior art.

In the conventional production of self-adhesive bonding products, such as a double-sided adhesive pad made from a PSA (Pressure Sensitive Adhesive), the corresponding part is cut out of a length or a sheet of an adhesive starting material by means of a die-cutting tool, in particular by a lifting or rotating movement. However, the disadvantage of these cut-out processes is the often not insignificant loss of the material used during contouring due to the resulting unusable offcuts. There is also a risk of the material sticking to the punching tool or becoming contaminated by liquid wetting agents, which are applied to improve the separation of the parts and the tool, or the degradation of solid release coatings applied to the tools. Finally, with these conventional punching processes, it is only possible to produce parts with a flat or plane-parallel shape.

EP 2 985 327 B1 describes a method for producing a pressure-sensitive adhesive layer, comprising the following steps:—introducing a crosslinkable polymer composition into a cavity of a print roller having at least one cavity,—inducing or causing a crosslinking reaction under the action of UV radiation and optionally actively supplying heat to produce an at least partially crosslinked pressure-sensitive adhesive layer, and—removing the at least partially crosslinked pressure-sensitive adhesive layer from the cavity. The polymer composition is inserted into the cavity of the print roller by means of an adhesive dosing device in combination with a scraper. The process is intended to make the production of flat die-cut parts more effective while avoiding cutting losses, whereby before, during and/or after inducing or effecting the cross-linking reaction to produce the pressure-sensitive adhesive layer, the cavity containing the prepolymer composition can be at least partially covered with a carrier film that can later be removed from the print roller, whereby preferably the pressure-sensitive adhesive layer adheres to the carrier film.

In fact—as explicitly stated at one point in EP 2 985 327 B1—a pressure-sensitive adhesive layer is printed on a carrier film. In this respect, an adhesive set with at least two components to be bonded together and a pressure-sensitive adhesive unit is also claimed, the adhesive set having the carrier film and the pressure-sensitive adhesive layer applied to the carrier film in the printing process for bonding the two components, on each of which a surface to be bonded is defined, the outline of which corresponds to the pressure-sensitive adhesive layer produced in the printing process. The manufacturing process is disadvantageously limited, in particular by its nature as a printing process, insofar as the depth of the cavity—and thus the thickness of the pressure-sensitive adhesive layer—with a base area of the cavity of at least 2 cm², preferably of at least 10 cm², can typically lie in a range from 50 μm to a maximum of only 3 mm.

Finally, the process requires the presetting of a certain minimum viscosity of the polymer composition so that it does not run out of the cavity of the print roller. So that the entire print roller does not have to be replaced when the mold is changed, the cavity can be placed in a replaceable print roller jacket.

EP 1 075 371 B1 discloses a further process of the type mentioned above for producing segmented pressure-sensitive adhesive layers and applying them to a substrate, according to which monomers and/or prepolymers of olefinically unsaturated compounds are injected into a mold with the addition of a photoinitiator as a reaction medium and then cured—induced by UV radiation—while polymerization and crosslinking reactions take place. In particular, the known process comprises the steps—that the reaction medium is kept ready under oxygen exclusion, in particular inertized by a nitrogen atmosphere, in a supply and filling station,—that empty stencils with a lower cover consisting of a film applied to a segment-defining aperture are conveyed one after the other—preferably in cycles—to a filling station and filled therein with a meterable amount of the reaction medium,—that the filled stencils are continuously transported under a UV path and the reaction medium is at least partially solidified in the process by means of radiation-induced polymerization,—that after removal of the lower cover during further transport between an upper and a lower UV section, the reaction medium which is then exposed at the top and bottom is cured from above and from below by a continued radiation-induced polymerization reaction to form a finished pressure-sensitive adhesive layer,—that the stencil containing the finished pressure-sensitive adhesive layer is transported to a transfer station and therein the pressure-sensitive adhesive layer is pressed out of the stencil and joined to a substrate. Teflon stencils with a milled cavity are used in particular.

The disadvantages of previously known methods for segmenting pressure-sensitive adhesive layers, in particular punching, scraping and screen printing, mentioned in the document, are thus to be overcome. As already mentioned here at the beginning, die-cutting has the disadvantage of comparatively large offcuts. Scraping—as well as screen printing—only allows the production of limited layer thicknesses, with the latter also requiring considerable effort for contouring.

By contrast, a design of the device for carrying out the method described, which provides that the stencils for holding the reaction medium have apertures, it should be possible to produce unrestricted segment-defining geometric shapes of the adhesive layer segments. By “unrestricted segment-defining geometric shapes” is meant above all the ground plan, which can be L-shaped, for example, as in the embodiment examples, whereby the stencils used for production do not have to be completely filled, so that the adhesive layer segments can have different thicknesses depending on the degree of filling of the stencil. The stencils themselves should have a thickness in the range between 0.5 mm and 6 mm.

In the above-mentioned EP 1 075 371 B1, the machine technology is emphasized as being particularly significant, especially the way in which the stencils used are conveyed and the delivery, pre-treatment and configuration of substrate parts, which are equipped with the adhesive layer segments produced, as well as their transfer via a star handle to a conveyor belt.

Both EP 1 075 371 B1 and EP 2 985 327 B1—as well as the die-cutting mentioned at the beginning—refer to the production of pressure-sensitive adhesive coatings or segmented pressure-sensitive adhesive coatings, i.e. to flat pressure-sensitive adhesive products for which a top surface running parallel to the base surface is characteristic in each case.

### SUMMARY

An objective of the present disclosure is to create a process of the type mentioned at the beginning, which allows a three-dimensional pressure-sensitive adhesive product to be produced in a simple and technologically less complex manner, which can also have a shape deviating from a flat shape or layer structure, i.e. in which the top surface and base surface do not necessarily run parallel to each other with a uniform layer thickness of the pressure-sensitive adhesive product. For example, it should also be possible to achieve shapes of the pressure-sensitive adhesive product with side surfaces inclined to the base and/or top surface or with curved side surfaces, such as a pyramid, a cone or a hemisphere, which are characterized by the fact that in the three-dimensional shape of the pressure-sensitive adhesive product not only a variably adjusted ground plan, but also variable heights, i.e. seen over the ground plan, can be present. In other words, the present disclosure is intended to overcome the disadvantages of the prior art, wherein the pressure-sensitive adhesive product should in particular also have a homogeneous structure, i.e. should not have an inner layer structure, for example, as is characteristic of products that are manufactured using a 3D printer.

The problem underlying the invention is solved by a process for the production of a three-dimensional pressure-sensitive adhesive product (HKP) from radiation-induced reactive prepolymer composition (SRP), comprising the process steps:
a. Provide a negative mold (NF) for the pressure-sensitive adhesive product (HKP),
b. Filling the negative mold (NF) provided with the radiation-induced reactive prepolymer mass,
c. Radiation-induced chemical conversion of the prepolymer mass (SRP) to the pressure-sensitive adhesive product (HKP), and
d. Removal of the pressure-sensitive adhesive product (HKP) from the negative mold,
   wherein the negative form or mold (NF) of the pressure-sensitive adhesive product (HKP) is produced by a thermoforming process using a positive mold (PF), in that a casting process for the radiation-induced reactive prepolymer mass (SRP) is used to fill the negative mold (NF) provided, and in that cooling (K) takes place during the radiation-induced chemical conversion of the prepolymer mass (SRP) to the pressure-sensitive adhesive product (HKP).

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 shows a schematic representation of a first embodiment of a method according to the teachings of the present disclosure;

FIG. 2 shows a schematic representation of a second embodiment of a method according to the teachings of the present disclosure; and

FIG. 3 shows an illustration of a manual removal of a pressure-sensitive adhesive product according to the teachings of the present disclosure from a negative mold.

The drawings are provided herewith for purely illustrative purposes and are not intended to limit the scope of the present invention.

### DETAILED DESCRIPTION

The following description is merely exemplary in nature and is in no way intended to limit the present disclosure or its application or uses. It should be understood that throughout the description, corresponding reference numerals indicate like or corresponding parts and features.

The present disclosure generally provides a process for the production of a three-dimensional pressure-sensitive adhesive product from radiation-induced reactive prepolymer composition, comprising the process steps:
a. Providing a negative mold for the pressure-sensitive adhesive product,
b. Filling the negative mold provided with the radiation-induced reactive prepolymer mass,
c. radiation-induced chemical conversion of the prepolymer mass to the pressure-sensitive adhesive product, and
d. Removal of the pressure-sensitive adhesive product from the negative mold.

To produce the negative mold of the adhesive product using a thermoforming process, a positive mold, i.e. a model, of the three-dimensional pressure-sensitive adhesive product to be produced can be made by machining or chipless means. The positive mold is used in the subsequent thermoforming process to produce a negative casting mold, i.e. a cavity. The model can be produced in various known ways, such as 3D printing, CNC milling or casting.

To produce the negative mold of the adhesive product using a thermoforming process, a positive mold, i.e. a model, of the three-dimensional pressure-sensitive adhesive product to be produced can be made by machining or chipless means. The positive mold is used in the subsequent thermoforming process to produce a negative casting mold, i.e. a cavity. The model can be produced in various known ways, such as 3D printing, CNC milling or casting.

To implement the thermoforming process itself, a sheet or plate of thermoplastic material is then clamped in a frame, heated with the aid of a heating element to a temperature appropriate to the material, which is necessary for the detailed molding of the outer contours of the positive mold, and then subjected to a deep-drawing process. The temperature can vary depending on the material used and the material thickness. The model, which represents the positive mold, is located under the frame with the clamped sheet or plate, preferably on a perforated base, such as a perforated plate.

A perforated release film is preferably placed on the positive mold before deep-drawing. This release film, which remains in the negative mold, then prevents the casting compound from sticking to the negative mold during the subsequent casting process. Furthermore, after the radiation-induced chemical conversion of the prepolymer mass to the pressure-sensitive adhesive product, the release film also makes it easier to remove the cast parts from the mold. The release film can be removed from the mold together with the cured pressure-sensitive adhesive product. For this purpose, the release film can be siliconized, fluorinated or similarly anti-adhesively equipped on one or both sides or consist of an anti-adhesive material itself. An anti-adhesive finish on one side only can optionally cause the release liner to adhere more strongly to either the negative mold or the pressure-sensitive adhesive product. For example, after removal from the negative mold, the release liner can optionally be used as a packaging medium for the pressure-sensitive adhesive product if it sticks to the latter more than to the negative mold. Anti-adhesive is understood to mean in particular a release film that has a release value of less than 1 N/cm according to a 180° peel test according to FINAT FTM 10 (February 2009), preferably a release value in the range of 0.05 cN/cm to 0.25 cN/cm.

Suitable materials for the release film include polyethylene (PE), polypropylene (PP), PE/PP blends and other deep-drawable polymers and polymer blends or compounds, both single-layer and multi-layer systems. The thickness of the release film can be in the range of 0.01 mm to 1.0 mm, preferably in the range of 0.015 mm to 0.040 mm.

After the sheet, which can also—taking into account the intended wall thickness of the negative mold—have a film character, or the thermoplastic sheet has been heated to the required temperature, the frame with the sheet or the sheet is lowered onto the perforated plate and the positive mold located thereon for deep-drawing and the air in the space between the sheet or the plate and the perforated plate is evacuated, in particular by means of a vacuum pump. The perforation of the release film placed on the positive mold ensures that when the air is evacuated, in particular by the vacuum pump, the air between the positive mold and the release film can also escape unhindered. It is particularly advantageous for a smooth, wrinkle-free, tight fit of the release film on the surface of the positive mold if the positive mold is also provided with a perforation. The sheet or plate made of thermoplastic material and the release film take on the shape of the outer contours of the positive mold. Everything then cools down and the negative mold solidifies. After a further brief cooling process, the positive mold can be removed, leaving behind the negative mold with the wall-lining release film inside, which is adapted to the inner contours.

The negative mold can have a thickness in the range of 0.05 mm to 10 mm, preferably in the range of 0.1 mm to 0.3 mm.

The negative mold produced by thermoforming, which can also consist of several connected individual molds, is then filled with the radiation-induced reactive prepolymer mass, in particular with a UV-reactive mass, preferably automatically, by means of a casting process. The prepolymer mass can in particular be an acrylate prepolymer mixture—preferably thickened in preparation either by partial polymerization or by the addition of other chemicals—which also contains one or more UV initiator(s), crosslinker(s) and possibly other components, such as pigments, polymeric or inorganic fillers and other reactive components, such as those that have an anti-shrinkage effect during polymerization and crosslinking and, in particular, during cooling of the radiation-induced polymer. Radiation-induced reactive prepolymer mixtures, in particular those which cure under the effect of UV radiation, are known per se, although their respective suitability for carrying out the process according to the present disclosure must be evaluated in a differentiated manner.

Adjusting the viscosity of the prepolymer mass is much less critical in the present disclosure than in the known process described above using a print roller due to the casting process used. A dosing device can advantageously be used to ensure a uniform filling quantity of the negative mold. On a laboratory scale, a laboratory balance is sufficient for weight control.

That cooling takes place according to the present disclosure during the radiation-induced chemical conversion of the prepolymer mass to the pressure-sensitive adhesive product takes account of the fact that the radiation-induced chemical conversion of the prepolymer mass to the pressure-sensitive adhesive product preferably takes place in an exothermic process. Cooling can be achieved in particular by using cooled inert gas and/or preferably by a water bath into which the negative mold is placed. Negative molds can also be floating conveyed in a water bath. This makes it possible to produce even high-volume pressure-sensitive adhesive products, especially those that exceed the dimensions mentioned at the beginning and known from the prior art, especially with regard to the thickness or height of the pressure-sensitive adhesive product, for example the 6 mm mentioned at the beginning in this regard, with homogeneous quality and in a comparatively short production time. This also prevents softening of the thermoplastic material of the negative mold or the release film.

The latter could also be counteracted by manufacturing the negative mold and the release film from a high-performance plastic. High-performance plastics are polymers with a glass transition temperature of over 280° C., such as fluoropolymers, e.g. polytetrafluoroethylene (PTFE), such as polyarylene ether ketones (PAEK), polyphenylenes, e.g. poly[di-(oxy-1,4-phenylene)carbonyl-1,4-phenylene] (polyetheretherketone, PEEK), poly[oxy-1,4-phenyleneoxy-di-(1,4-phenylenecarbonyl-1,4-phenylene] (polyetheretherketoneketone, PEEKK) or poly[oxy-1,4-phenylenecarbonyl-1,4-phenyleneoxy-di-(1,4-phenylenecarbonyl)-1,4-phenylene] (polyetherketoneetherketoneketone, PEKEKK), or polyarylene sulphides such as polyphenylene sulphide (PPS). Such materials are very dimensionally stable at high temperatures, but are also cost-intensive and require a much higher energy input in the thermoforming process than the usual technical thermoplastic materials. The use of the latter or even standard plastics for the negative mold in combination with cooling is therefore the optimal solution. Technical plastics such as PA, TPE, PBT, PET, POM, PC or PMMA are known to be a subgroup of thermoplastics and are differentiated from standard or mass plastics such as PP, PE, PS or PVC, high-performance plastics and functional plastics in terms of properties and price, even if the classification is not clear-cut. Compared to standard plastics, they have better mechanical properties such as greater impact strength and/or higher elastic moduli and are therefore also suitable for technical applications and some construction applications. Occasionally, technical plastics are also defined by the fact that their mechanical characteristics and dimensional stability are maintained even in some temperature ranges below 0° C. or above 100° C.

According to one aspect of the present disclosure, the individual features of the invention, namely that the negative mold of the pressure-sensitive adhesive product is produced from a positive mold by a thermoforming process, that a casting process for the radiation-induced reactive prepolymer mass is used to fill the negative mold provided and that cooling takes place during the radiation-induced chemical conversion of the prepolymer mass to the pressure-sensitive adhesive product, as explained above—work together advantageously synergistically in the production of a pressure-sensitive adhesive product according to the present disclosure, whereby the preferably used perforated release film is also of great technological importance.

A pressure-sensitive adhesive product produced according to one aspect of the present disclosure can thus have a variety of three-dimensional shapes, in particular a spatial shape which is characterized by a pyramid, such as a tetrahedron, by a trapezoid, by a cone, by a hemisphere, by an ellipsoid flattened at the base or by an elliptical or hyperbolic paraboloid flattened at the base or by geometric shapes derived therefrom, such as a truncated pyramid, a truncated cone, a spherical segment, a cylinder or a prism with a spherical, conical or pyramidal top or a regular or irregular polyhedron with a flat bottom surface. All these three-dimensional spatial formations of a pressure-sensitive adhesive product according to the present disclosure can be easily realized with undercut-free negative shapes.

The invention is explained in more detail with reference to several embodiments of the present disclosure illustrated by the accompanying drawings.

With regard to the following description, it is expressly emphasized that the present disclosure is not limited to the embodiment example and also not limited to all or several features of the described feature combinations. Rather, each individual sub-feature of the embodiment example can also have an inventive significance independently of all other sub-features described in connection therewith and also in combination with any other features.

In the figures in the drawing, identical and corresponding parts are always provided with the same reference symbols, so that they are generally only described once each.

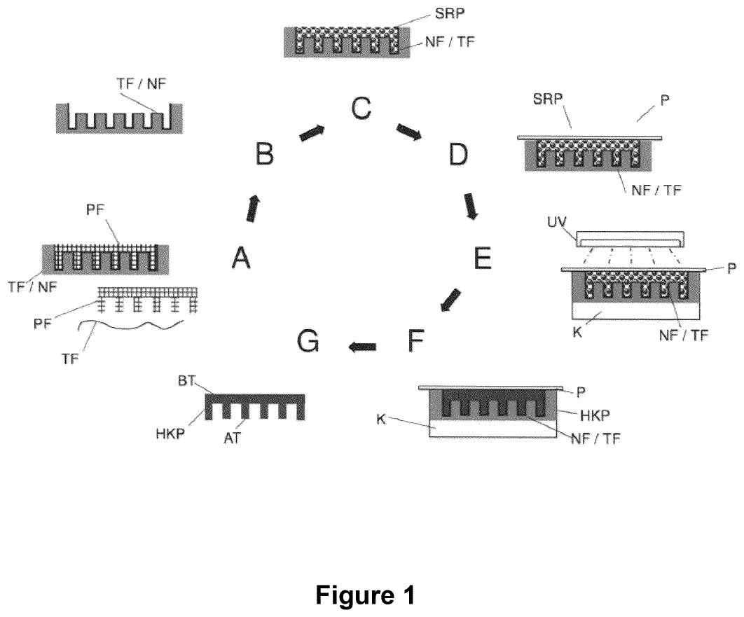

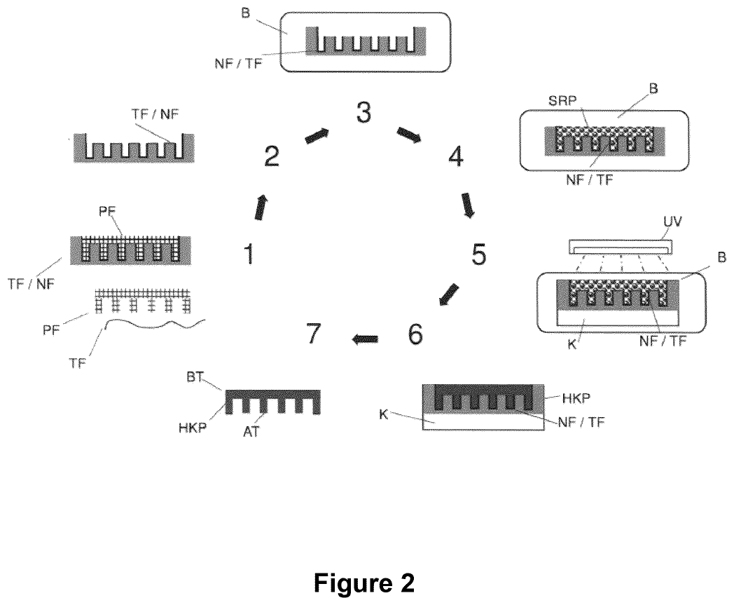

As FIG. 1 and FIG. 2 illustrate, a method according to the present disclosure for producing a three-dimensional pressure-sensitive adhesive product HKP from radiation-induced reactive prepolymer composition SRP comprises the following method steps:
a. Providing a negative mold NF for the pressure-sensitive adhesive product HKP, which is indicated in FIG. 1 by the letter B and in FIG. 2 by the number 2;
b. Filling the negative mold NF provided with the radiation-induced reactive prepolymer SRP, which is indicated in FIG. 1 by the letter C and in FIG. 2 by the number 4;
c. Radiation-induced chemical conversion of the prepolymer SRP to the pressure-sensitive adhesive HKP—symbolized by the letter E in FIG. 1 and by number 5 in FIG. 2; and
d. Removal of the pressure-sensitive adhesive product HKP from the negative mold NF, for which the transition from letter F to letter G is shown in FIG. 1 and the transition from number 6 to number 7 is shown in FIG. 2. The pressure-sensitive adhesive product HKP shown as an example consists of a plate-like base part BT, to which six prismatic or cylindrical parts are connected homogeneously and in one piece as top parts AT.

According to another aspect of the present disclosure, it is provided that the negative form NF of the pressure-sensitive adhesive product HKP is produced from a positive form PF by a thermoforming process step, wherein in particular a release film TF, in particular a perforated one, is placed on the positive form PF before the thermoforming process step is carried out. This is illustrated in FIG. 1 by the letter A and in FIG. 2 by the number 1.

Common to both process variants is cooling K in a water bath during the radiation-induced chemical conversion of the prepolymer mass SRP to the pressure-sensitive adhesive product HKP (letter E or number 5) and also the final process step, for which the letter G stands in FIG. 1 and the number 7 in FIG. 2, namely that the pressure-sensitive adhesive product HKP is released from the negative mold NF and fed to its use.

The two process variants differ in the step symbolized by the letter D in FIG. 1 and the step designated by the number 3 in FIG. 2. Whereas in the first process variant, the filled negative mold NF is sealed with a transparent, or at least UV-permeable, plastic designed as a sheet P (or also as a film) in order to prevent oxidative oxygen attack on the prepolymer mass SRP during its UV-radiation-induced conversion to the pressure-sensitive adhesive product HKP, in the second process variant, the negative mold NF is placed in a closed chamber B with a protective gas atmosphere even before the negative mold NF is filled with the reactive prepolymer composition SRP.

The process according to the present disclosure can advantageously be practiced continuously or cyclically with reuse of the negative mold NF.

### Embodiment Example (Laboratory Scale)

First, with the aid of CAD (Computer Aided Design), a positive mold PF of the pressure-sensitive adhesive product HKP to be produced was prepared in a 3D printer. In particular, this was a positive mold PF that depicted six individual molds. In the subsequent thermoforming process to produce the negative mold NF, a 0.5 mm thick sheet made of polystyrene (HIPS) was clamped in a frame and heated to a temperature of 160° C. using a ceramic heating element, which was necessary for the detailed molding of the outer contours of the positive mold PF. The positive mold PF was located under the frame with the clamped plate on a perforated plate. A perforated release sheet TF was placed on the positive mold PF. The frame together with the PS plate was then lowered onto the perforated plate and the positive mold PF on top of it and the air was extracted using a vacuum pump. The plate and the release film TF took on the shape of the outer contours of the positive mold PF. The perforation ensured that when the air was evacuated by the vacuum pump, the air between the positive mold PF and the sheet or film could escape unhindered. After cooling to room temperature, the positive mold PF could be removed, leaving behind the negative mold NF with the release film TF adapted to its contours.

A UV-reactive pre-polymer mass SRP was then cast into the negative mold NF with its six individual molds produced by thermoforming.

A prepolymer composition SRP which is particularly suitable for the method according to the present disclosure is considered to be one in which—in contrast to widely practiced crosslinking techniques which are used in the production of acrylate adhesives and are aimed at achieving a high tack and high adhesive cohesion—the degree of crosslinking of the pressure-sensitive adhesive product HKP according to the present disclosure can be designed in such a way that the pressure-sensitive adhesive product HKP can already be deformed by applying a small amount of manual pressure. However, in order to prevent spontaneous flow of the pressure-sensitive adhesive product HKP according to the present disclosure under the conditions of use in practice and thus to restrict the flow behavior, it is expedient that the prepolymer composition SRP should contain small amounts of multi-functional acrylate monomers, “multi-functional” being understood to mean that a monomeric alkyl acrylate used in the prepolymer composition SRP contains more than one acrylic group (CH₂═CH—COR). This provides a number of free valencies in the molecules for or during polymer formation, which enable polymerization to take place with simultaneous crosslinking. As a result, not only polymer chains but also a three-dimensional network are formed, which is advantageously characterized by the presence of rubber elasticity.

For example, the polyalkyl acrylate may contain 89.9% by mass to 99.9% by mass, preferably 98.0% by mass to 99.9% by mass, of one or more alkyl acrylate monomers having 4 to 20 carbon atoms in the alkyl chain and 0% by mass to 10.0% by mass, preferably 0 mass % to 1.9 mass %, of acrylic acid and/or methacrylic acid and 0.1 mass % to 1.0 mass % of one or more photo initiators which absorb UV light in the range from 200 nm to 400 nm, preferably in the range from 315 nm to 380 nm. UV-A radiation is used for crosslinking in the preferred wavelength range. In particular, the polyalkyl acrylate may contain 0.01% to 1.0% by mass of an alkyl diol diacrylate monomer or an alkyl triol triacrylate with 4 to 20 carbon atoms in the alkyl chain.

The filled negative mold NF was placed in a container with a water bath. The negative mold NF was designed in such a way that it generated an uplift in the water bath and had no contact with the bottom of the container. It therefore floated in the water bath. This ensured optimum cooling during the subsequent radiation induced chemical conversion of the prepolymer mass SRP to the pressure-sensitive adhesive HKP, in particular preventing the polystyrene of the negative mold NF from reaching its melting point during polymer formation.

The container with the water bath was covered from above with a cover that was permeable to UV radiation. In deviation from the process sequence shown in FIG. 1, the container was only now filled with a protective gas, in particular nitrogen. The cover was only resting on its own weight and was not firmly closed. The gas permanently introduced from the lower range of the container pressed out the air oxygen between the cover and the container. The permanent excess pressure of inert gas in the container prevented ambient air from penetrating again.

As soon as the closed container was completely flooded with the inert gas, the radiation-induced chemical conversion of the prepolymer mass SRP to the pressure-sensitive adhesive HKP could begin in process step c. using UV light with a wavelength in the range from 200 nm to 400 nm, preferably in the range from 315 nm to 380 nm. A radiation dose in the range of 400 mJ/cm² to 600 mJ/cm² can be selected for the polymerization and/or crosslinking that occurs. The duration of the irradiation varies depending on the filling level of the compound in the casting molds. The negative mold NF was then removed from the container with the adhesive products HKP.

The individual cast parts could be easily removed from the negative mold NF thanks to the previously co-molded release film TF. Furthermore, the latter could alternatively—used as a disposable mold—also serve as packaging for the pressure-sensitive adhesive products HKP. For this purpose, the negative mold NF was provided with a cover after UV irradiation, whereby the pressure-sensitive adhesive products HKP could be stored and transported in a blister pack produced in this way without any further work step. From this point of view, it should also be noted that in the process step in which the release film TF is placed on the positive mold PF before the thermoforming process is carried out, the material of the negative mold NF is used for this purpose, so that the release film TF is then formed by the negative mold NF itself.

In particular, it was possible in this way to produce pressure-sensitive adhesive products HKP according to the present disclosure which consist of radiation-crosslinked polyalkyl acrylate which is crosslinked in such a way that its elongation according to ISO 527-2/1BA/300 at a material thickness of 1.5 mm is more than 500%, in some cases even more than 1000%, and its shear strength according to DIN EN 1943 (tested according to method A, 625 mm² contact area) is less than 1000 min. On the other hand, however, it is also possible to manufacture pressure-sensitive adhesive products HKP with a shear strength of over 10,000 min.

In such a pressure-sensitive adhesive product HKP according to the present disclosure, a balanced ratio of adhesion and cohesion can be set not only with regard to preferred applications as a PSA (Pressure Sensitive Adhesive), but also with regard to an intended use as a sealant.

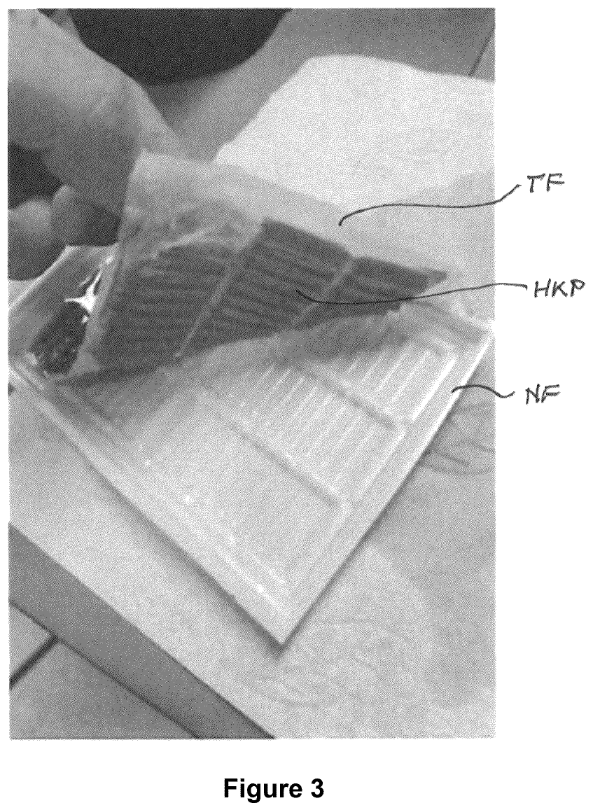

A manual removal of pressure-sensitive adhesive products HKP produced according to the present disclosure and coated with the release film TF from a negative mold NF is shown as an example in FIG. 3.

A person skilled in the art can also supplement the present disclosure with further advantageous technical measures without departing from the scope of the invention.

For example, according to one aspect of the present disclosure, it is also possible to produce three-dimensional shapes with undercuts if required.

For this purpose, two complementary negative molds NF1, NF2 can be produced in the deep-drawing process as described, one of which is not only open on one side, i.e. at the top, but also has an opening on the other side, i.e. at the bottom, which then forms the top casting opening for the radiation-induced reactive prepolymer mass SRP after the two half-molds have been joined to form an overall negative mold NF, for example by thermal sealing at the edges or by bonding.

During the radiation-induced chemical conversion of the prepolymer mass SRP, the upper half mold then largely replaces the cover plate P shown in FIG. 1. It should therefore preferably have a corresponding transparency, for example by being made of an amorphous thermoplastic. To remove the adhesive product from the negative mold NF, however, the overall negative mold NF must then be destroyed, which, however, hardly seems critical in view of the fact that the negative mold NF does not have to be made of a high-priced material and can also be used as packaging for the pressure-sensitive adhesive product HKP and that several pressure-sensitive adhesive products HKP according to the present disclosure can be produced with a multi-part negative mold NF.

A further advantage of the present disclosure is that the wall thickness of the negative mold NF—compared to the state of the art mentioned at the beginning (print roller with or without support, milled Teflon mold)—can be much smaller, since the negative mold NF does not consist of a solid body with a cavity, because the wall thickness can be kept essentially constant during the formation of the negative mold NF in the thermoforming process, i.e. in particular during deep-drawing, and thus predetermines the later outer shape of the pressure-sensitive adhesive product HKP, which also favors cooling.

However, positive mold PF and negative mold NF can alternatively be designed as metal molds without departing from the scope of the present disclosure. For the negative mold NF, this means that it can advantageously be used several times in a cyclic process. Such a metal mold also has improved heat conduction compared to a plastic mold. A further advantage is that the release film TF does not need to be perforated during its manufacture.

Furthermore, the present disclosure is not limited to the combinations of features defined in specific embodiments shown, but can also be defined by any other combination of certain features of all the individual features disclosed herein. This means that, in principle, virtually any individual feature in embodiment can be omitted or replaced by at least one individual feature disclosed elsewhere in the application. In other words, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

1. A process for the production of a three-dimensional pressure-sensitive adhesive product (HKP) from radiation-induced reactive prepolymer composition (SRP), comprising the process steps:
a. Provide a negative mold (NF) for the pressure-sensitive adhesive product (HKP),
b. Filling the negative mold (NF) provided with the radiation-induced reactive prepolymer mass,
c. Radiation-induced chemical conversion of the prepolymer mass (SRP) to the pressure-sensitive adhesive product (HKP), and
d. Removal of the pressure-sensitive adhesive product (HKP) from the negative mold,
wherein the negative mold (NF) of the pressure-sensitive adhesive product (HKP) is produced by a thermoforming process step using a positive mold (PF), in that a casting process for the radiation-induced reactive prepolymer mass (SRP) is used to fill the negative mold (NF) provided, and in that cooling (K) takes place during the radiation-induced chemical conversion of the prepolymer mass (SRP) to the pressure-sensitive adhesive product (HKP).

2. The method according to claim 1, wherein in order to produce the negative mold (NF) of the pressure-sensitive adhesive product (HKP), a positive mold (PF) of the pressure-sensitive adhesive product (HKP) is first produced by metal cutting or chipless means, for example by 3D printing, CNC milling or casting, and then a sheet or a plate of thermoplastic material is clamped in a frame and heated to a temperature which is necessary for a detailed molding of the outer contours of the positive mold (PF) by the thermoplastic material, after which the sheet or plate of thermoplastic material is subjected to deep-drawing to form the negative mold (NF).

3. The method according to claim 1, wherein the negative form (NF) has a thickness in the range from 0.05 mm to 10 mm, preferably in the range from 0.1 mm to 0.3 mm.

4. The method according to claim 1, wherein a release film (TF), in particular a perforated one, is placed on the positive mold (PF) before the thermoforming process step is carried out.

5. The method according to claim 4, wherein the materials used for the release film (TF) are single-layer or multi-layer systems of polyethylene (PE), polypropylene (PP), PE/PP blends or other deep-drawable polymers, polymer blends or polymer compounds.

6. The method according to claim 4, wherein the release film (TF) has a thickness in the range from 0.01 mm to 1.0 mm, preferably in the range from 0.015 mm to 0.040 mm.

7. The method according to claim 1, wherein the positive mold (PF) is located on a perforated base, such as a perforated plate, during the thermoforming process step.

8. The method according to claim 2, wherein during the thermoforming process step, in particular during deep-drawing, the frame with the sheet or the plate made of the heated thermoplastic material is lowered onto the perforated base and the positive mold (PF) located thereon with the release film (TF) lying thereon and the air in the space between the sheet or the plate and the perforated base is sucked out, in particular by means of a vacuum pump, so that the sheet or the plate and the release film (TF) are lowered onto the perforated base, forming the negative, in particular by means of a vacuum pump, the air in the space between the sheet or the plate and the perforated base is sucked out so that the sheet or the plate and the release film (TF) assume the shape of the outer contours of the positive mold (PF), forming the negative mold (NF).

9. The method according to claim 1, wherein the positive mold (PF) is separated from the negative mold (NF) after cooling, which takes place after the thermoforming process step, with a/the release film (TF) remaining in the negative mold (NF) as a wall lining.

10. The method according to claim 4, wherein the release film (TF) is siliconized, fluorinated or similarly anti-adhesively equipped on one or both sides or itself consists of an anti-adhesive material.

11. The method according to claim 4, wherein the release film (TF) forms a packaging medium for the pressure-sensitive adhesive product (HKP), in particular after the pressure-sensitive adhesive product (HKP) has been removed from the negative mold (NF).

12. The method according to claim 1, wherein after removal of the pressure-sensitive adhesive product (HKP), the negative mold (NF) is reused for refilling with the radiation-induced reactive prepolymer composition (SRP) and for renewed radiation-induced chemical conversion of the prepolymer composition (SRP) to form the pressure-sensitive adhesive product (HKP), if appropriate after refitting with a release film (TF).

13. The method according to claim 1, wherein the pressure-sensitive adhesive product (HKP) is removed from the negative mold (NF) only at the place of use of the pressure-sensitive adhesive product (HKP), so that the negative mold (NF) as a disposable product forms a packaging medium for the pressure-sensitive adhesive product (HKP).

14. The method according to claim 1, wherein the positive form (PF) is perforated.

15. The method according to claim 1, wherein the negative mold (NF) consists of several contiguous individual molds for several pressure-sensitive adhesive products (HKP) that can be produced simultaneously.

16. The method according to claim 1, wherein the negative mold (NF) consists of an engineering plastic or of a standard plastic or of metal, such as steel.

17. The method according to claim 1, wherein during the casting process, the negative mold (NF) is filled with the radiation-induced reactive prepolymer composition (SRP), in particular with a UV-reactive composition (SRP) which is an acrylate prepolymer mixture—preferably thickened either by partial polymerization or by the addition of other chemicals—which optionally contains one or more UV initiator(s), crosslinker(s) and optionally other components, such as, for example, pigments, polymeric or inorganic fillers and other reactive components. pigments, polymeric or inorganic fillers, and other reactive components.

18. The method according to claim 1, wherein the radiation-induced reactive prepolymer composition (SRP) contains
89.0% to 99.9% by mass, preferably 98.0% to 99.9% by mass, of one or more alkyl acrylate monomers having 4 to 20 carbon atoms in the alkyl chain, and
0% to 10.0% by mass, preferably 0% to 1.9% by mass, of acrylic acid and/or methacrylic acid and
0.1% to 1.0% by mass of one or more photoinitiators which absorb UV light in the range from 200 nm to 400 nm, preferably in the range from 315 nm to 380 nm.

19. The method according to claim 1, wherein during the radiation-induced chemical conversion of the prepolymer mass (SRP) to the pressure-sensitive adhesive product (HKP), oxygen is sealed off by an inert gas, such as nitrogen, argon or carbon dioxide, or by covering the negative mold (NF).

20. The method according to claim 1, wherein the cooling (K) during the radiation-induced chemical conversion of the prepolymer mass (SRP) is carried out by a/the cooled inert gas(es) and/or preferably in a water bath into which the negative mold (NF) is placed.

21. The method according claim 1, wherein during cooling (K) in a/the water bath, the negative mold (NF) floats in the water bath and is transported floating in the water bath if necessary.

22. The method according to claim 1, wherein the radiation-induced chemical conversion of the prepolymer composition (SRP) to the pressure-sensitive adhesive product (HKP) takes place as polymerization and/or crosslinking under the action of UV-A radiation.

23. The method according to claim 1, wherein the radiation-induced chemical conversion of the prepolymer mass (SRP) to the pressure-sensitive adhesive product (HKP) takes place under the influence of a radiation dose which is in the range from 400 mJ/cm² to 600 mJ/cm².

24. A three-dimensional pressure-sensitive adhesive product (HKP), having at least one top surface and at least one bottom surface, producible in a process according to claim 1, wherein the top surface and the bottom surface are not plane-parallel to each other and/or that side surfaces, if present, are inclined and/or curved.

25. The pressure-sensitive adhesive product (HKP) according to claim 24, wherein a spatial shape which is represented by a pyramid, such as, for example a tetrahedron, by a trapezoid, by a cone, by a hemisphere, by an ellipsoid flattened at the base or by an elliptical or hyperbolic paraboloid flattened at the base or by geometric shapes derived therefrom, such as a truncated pyramid, a truncated cone, a spherical segment, a cylinder or a prism with a spherical, conical or pyramidal top or a regular or irregular polyhedron with a flat bottom surface.
